(19) United States
(12) Patent Application Publication
(10) Pub. No.: US 2012/0323728 A1
(43) Pub. Date: Dec. 20, 2012

(54) Gift Registry System for Managing Products and Services Offered by Multiple Online Stores

(75) Inventors: Kiran K. M. Mutukuru, Miami, FL (US); William P. Shaouy, Atlanta, GA (US); Matthew A. Terry, Dunwoody, GA (US)

(73) Assignee: INTERNATIONAL BUSINESS MACHINES CORPORATION, Armonk, NY (US)

(21) Appl. No.: 13/163,398

(22) Filed: Jun. 17, 2011

(51) Int. Cl. G06Q 30/00

(52) U.S. Cl. 705/26.8

(57) ABSTRACT

A method and apparatus for managing a gift registry is disclosed. A gift registry system identifies attributes for a first item and a group of definitions for the set of attributes of the first item. The gift registry system selects a definition for the first item from the group of definitions using a rule for selecting definitions. The gift registry system then identifies a second item for the gift registry using the definition selected using the rule for selecting definitions. The second item has a set of attributes that meet the definition.

### BACKGROUND

1. Field

The disclosure relates generally to data processing systems and, in particular, to managing products and services. Still In particular, the present disclosure relates to searching for products and services sold by vendors to be offered in a gift registry.

2. Description of the Related Art

The Internet is a global system of computer networks that are connected to each other. These networks may be public, government, and/or other types of networks. The Internet is used to provide various services and content to users. For example, many users may visit websites to obtain information, download files, purchase goods and services, make financial transactions, and perform other operations.

Organizations put up websites on the Internet to provide and sell their products and services. Each organization's website seeks the attention of the buying public. However, getting the attention of the buying public can be expensive and difficult to achieve. Users may be unaware of the existence of the organization or unaware of the types of products and services sold by the organization. One solution is to employ advertising to grab the attention of the user, but advertising can be expensive and miss the intended audience. Further, users may be adverse to advertisements. Another solution is for organizations to sell through an Internet based retailer who in turn sells products from many organizations. Selling through an Internet based retailer, however, may be unacceptable to the organization. An organization may be, for example, a retailer, a vendor, a non-profit organization, a government entity, or some other suitable type of organization. Therefore, it would be advantageous for organizations to find other ways to make users aware of the products and services they have for sale.

When a user buys a product or service, on many occasions the purchase is for a gift. When gift giving, users would prefer to pick out gifts that will be well received by the gift receiver. An exchange of gift lists between gift givers and gift receivers may increase the likelihood that a gift is well received. However, in order to make sure each gift will be well received, each gift on the list needs to be researched. For example, a gift having poor quality or lacking desirable features may not be well received.

Because of the amount of research required and the number of possible products and services, a gift list can take more time to prepare than desired. Therefore, it would be advantageous to speed up the process of making a gift list. Further, at any point in time, the gifts on the gift list may become out of stock, hard to find, or otherwise unavailable. Still further, gift givers may desire to purchase gifts of a different brand, price range, or quality than the gifts on the gift list. Some life events, such as weddings, may be associated with the giving of gifts by friends, relatives, and associates. Gift givers and gift receivers may desire the gifts to be unique on these occasions. But the number of people providing gifts to a gift receiver may be large. As the number of gift givers goes up, the chance that two or more gift givers will choose the same gift increases. The user may not know what gifts have already been given. Further, even if a user did know what gifts have already been given, he may not know two different gifts on the list provide the same function.

One solution to some of these problems is for organizations to provide a gift registry to manage gift lists on their website. However, users using gift registries on these websites are limited to the products and services made available to them on the website. As a result, a user may have multiple gift lists on different websites if the user cannot find all of the items that the user wants on one organization's website.

Another solution to some of these problems is to provide a way for users to make and browse recommendations of the products and services made available on a website. However, the recommendations made on these websites are likely made from persons unknown to the user. As a result, the recommendation may not be as reliable as desired based on the user's preferences.

Accordingly, it would be advantageous to have a method and apparatus, which takes into account one or more of the issues discussed above, as well as possibly other issues.

### SUMMARY

The present disclosure provides a method, apparatus, and computer program product for managing a gift registry. A computer system identifies a first set of attributes for a first item and a group of definitions describing the first set of attributes of the first item. The computer system selects a definition for the first item from the group of definitions using a rule for selecting definitions. The computer system then identifies a second item for the gift registry using the definition selected using the rule for selecting definitions. The second item has a set of attributes that meet the definition.

### BRIEF DESCRIPTION OF THE SEVERAL VIEWS OF THE DRAWINGS

FIG. 1 is an illustration of a gift registry environment in accordance with an illustrative embodiment;

FIG. 2 is an illustration of a gift registry system in accordance with an illustrative embodiment;

FIG. 3 is an illustration of a web page in accordance with an illustrative embodiment;

FIG. 4 is an illustration of a user interface of a gift registry comprising items matching a current interest of a user in accordance with an illustrative embodiment;

FIG. 5 is an illustration of an item of a web page in accordance with an illustrative embodiment;

FIG. 6 is an illustration of attribute definitions in accordance with an illustrative embodiment;

FIG. 7 is an illustration of a mapping of a user to friends of the user and to product recommendations made by the friends in accordance with an illustrative embodiment;

FIG. 8 is a diagram illustrating steps in a process for identifying products related to current interests in accordance with an illustrative embodiment;

FIG. 9 is an illustration of a flowchart of a process for identifying a list of items related to a selected item in accordance with an illustrative embodiment;

FIG. 10 is an illustration of a flowchart of a process to identify a list of approved product recommendations in accordance with an illustrative embodiment;

FIG. 11 is an illustration of a flowchart of another process for identifying a list of items related to a selected item in accordance with an illustrative embodiment; and

FIG. 12 is an illustration of a data processing system in accordance with an illustrative embodiment.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object-oriented programming language, such as Java, Smalltalk, C++, or the like, and conventional procedural programming languages, such as the “C” programming language or similar programming languages. The program code may run entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowcharts and/or block diagrams of methods, apparatus (systems), and computer program products according to embodiments of the invention. It will be understood that each block of the flowcharts and/or block diagrams, and combinations of blocks in the flowcharts and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which run on the computer or other programmable apparatus provide processes for implementing the functions/acts specified in the flowchart and/or block diagram block or blocks.

The illustrative embodiments recognize and take into account a number of different considerations. “A number”, as used herein with reference to items, means one or more items. For example, “a number of considerations” is one or more considerations.

The illustrative embodiments recognize and take into account that the Semantic Web enables a computer to identify the semantics on a network. Semantics, is the meaning of information that may be found on a network. The Semantic Web extends human-readable web pages by inserting machine-readable semantic information about the web pages. In particular, computers that use the Semantic Web technology may use the machine-readable semantic information inserted into the web pages to perform tasks on behalf of users. “Meaning”, as used herein, refers to particular definitions. “Semantic”, as used herein, means of, pertaining to, or arising from the different meanings of words or other symbols.

The illustrative embodiments also recognize and take into account that social networks allow users to join the social network and define relationships to the other users in the network. In particular, social networks may also allow a user to recommend products and to state what their current interests are. These social networks may use Semantic Web vocabularies to define content comprised within the social network. For example, MeNow is a Semantic Web vocabulary that allows users to describe and publish their current interests. Current interests may include a book being read, music being listened to, a hobby, or any other suitable description of a current interest. In this example, when the owner of a gift registry publishes that he is reading a particular book using a Semantic Web vocabulary such as MeNow, users buying products for the owner can then search for the current interests of the owner and make decisions with this information. The current interests of the owner are particularly helpful where a user wants to surprise the owner with a gift and does not want to buy an item listed in the owner's gift registry.

The illustrative embodiments further recognize and take into account that existing products on existing vendor websites are found in web pages in the vendor website. The products in these web pages are described in the web pages using information. When a user of the website browses a product on the website, the information used to describe the product is provided to the user. In particular, when the user browses the product the user will know semantics about the information provided to the user. “Browse” or “browsing”, when used with reference to users, means users accessing and using web pages of a website. For example, a user using a web browser to look at information, select items, and purchase items on a website is said to be “browsing” the website.

For example, a user familiar with digital cameras browses a camera on a web page. The information shown to the user is a picture of a small camera and the words “digital camera.” In this example, the user will see the picture of the small camera and read the words “digital camera.” However, when the user sees the picture and reads the words the user is also thinking about the semantics of the picture and words that are not explicitly shown by the picture or described in the words.

In this example, the semantics the user is thinking about may include “used for taking photos”, “consumer product”, “used by casual photographers”, “used by people with smaller hands”, “used by people who desire products that are portable”, “used by people that desire items that fit in a pocket or purse”, and/or other suitable semantics for the small, digital camera. Thus, semantics, as understood by a user, also include the implied meanings of information as understood by the user. Semantics can be very useful for identifying and describing products. However, programming computers to think like users and to determine semantics from information about products on websites as users do would be a very difficult task.

The illustrative embodiments also recognize and take into account that gifts on a gift list may have more than one purpose and that product attribute types may have more than one attribute definition. As a result, the illustrative embodiments also recognize and take into account that an owner or other user of a gift registry may benefit from rules that choose the purpose of the product and the definition of an attribute type of a product. With this situation, the different illustrative embodiments recognize and take into account that a gift registry using these embodiments may improve the chance that a gift will be well received.

“Attribute type”, as used herein, refers to the particular type of an attribute. For example, “author” is an attribute type used to indicate that the attribute is the author of a product.

“Attribute definition”, as used herein, refers to a particular definition of a particular attribute type. For example, one attribute definition of “author” may mean “sole author of a product”. In this and other examples, another attribute definition of “author” may mean “writer” or “ghost writer of a product”.

Thus, the different illustrative embodiments provide a method and apparatus to manage a gift registry. Particularly, the different illustrative embodiments may use a process for adding items to a gift registry. For example, a gift registry system may retrieve attributes for a first item and a group of definitions for the set of attributes of the first item. The gift registry system may select a definition for the first item from the group of definitions using a rule for selecting definitions. The gift registry system may then identify a second item for the gift registry using the definition selected using the rule for selecting definitions. For example, the gift registry system may identify a second item when the second item has a set of attributes that meet the selected definition.

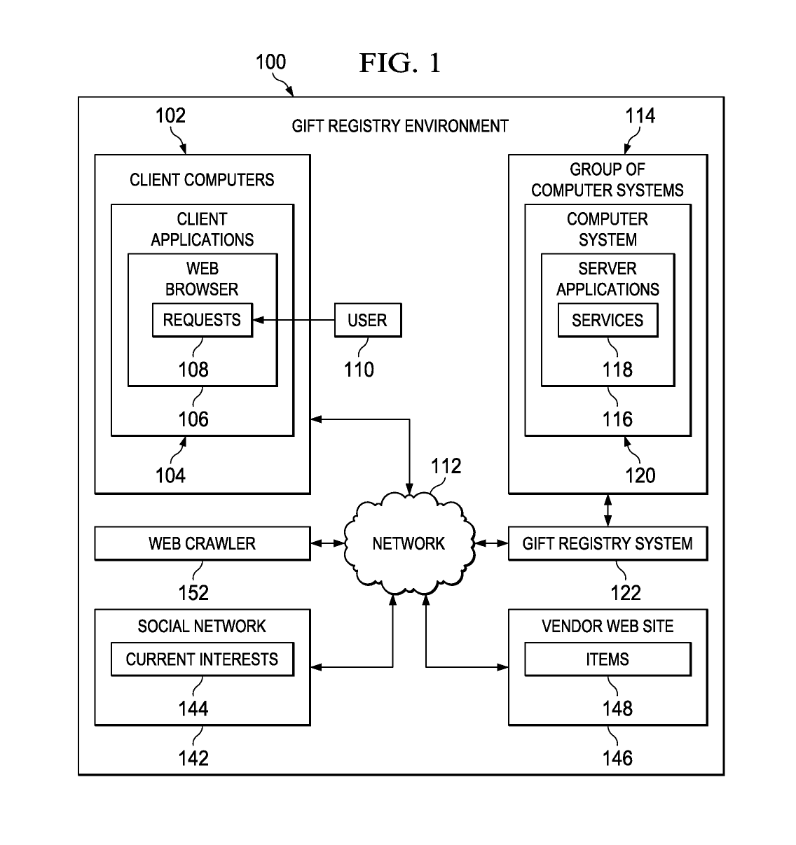

With reference now to the figures and, in particular, with reference now to FIG. 1, an illustration of a gift registry environment is depicted in accordance with an illustrative embodiment. In this illustrative example, gift registry environment 100 is depicted in block diagram form in accordance with an advantageous embodiment.

Client applications 104 run on client computers 102 within gift registry environment 100. Client applications 104 may take various forms. For example, client applications 104 may be at least one of web browser 106, a database application, a web crawler, and/or other suitable types of applications.

As used herein, the phrase “at least one of”, when used with a list of items, means that different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C. In other examples, “at least one of” may be, for example, without limitation, two of item A, one of item B, and 10 of item C; four of item B and seven of item C; and other suitable combinations.

A “web crawler”, is a computer program or device that browses network web pages. When the web crawler is browsing the network web pages, it may perform specific tasks. Typical tasks of a web crawler include creating an index of the information in the web pages it browses. In particular, the index is then used by computers to search for the information. “Browse” or “browsing”, as used herein, with reference to computer systems and searching, means computer systems accessing, parsing, and using web pages of a website. For example, a computer system parsing web pages of a website searching for items in content on the web pages of the website is said to be “browsing” the website.

As depicted, client applications 104 used by user 110 generate requests 108 for services 118. Services 118 may include, for example, at least one of retrieving a file, retrieving a web page, retrieving information, writing information, downloading a program, and/or other suitable types of access.

In these illustrative examples, requests 108 are sent over network 112 to gift registry system 122. Gift registry system 122 sends requests 108 to server applications 116 located on computer system 120 in group of computer systems 114. A computer system is one or more computers in these illustrative examples. Server applications 116 may be any applications configured to process requests 108 to provide services 118. Server applications 116 may be, for example, at least one of a database server, a file transfer protocol (FTP) server, a web server, a mail server, and/or other suitable types of applications.

In these illustrative examples, computer system 120 within group of computer systems 114 is one or more computers. When computer system 120 is more than one computer, the computer system may take the form of a computer cluster, group of computer systems 114, or other configurations of computer systems configured to run server applications 116.

Gift registry system 122 may be implemented using hardware, software, or a combination of the two. When implemented with hardware, the hardware may take the form of a circuit system, an integrated circuit, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices may include, for example, a programmable logic array, programmable array logic, a field programmable logic array, a field programmable gate array, and/or other suitable hardware devices. Additionally, gift registry system 122 may be implemented in organic components integrated with inorganic components and/or may be comprised entirely of organic components excluding a human being. When processor units are used in hardware, these processor units may be located on the same or different computers.

In these illustrative examples, gift registry system 122 is configured to manage a gift registry in group of computer systems 114. Requests 108 are processed by gift registry system 122. Gift registry system 122 searches social network 142 to find current interests 144. Current interests 144 may be described in social network 142 using a Semantic Web vocabulary. Gift registry system 122 searches vendor websites in vendor website networks for products and services sold by the vendor. The products and services sold by a vendor may be described as items 148 in vendor website 146. In particular, user 110 may identify items 148 for use in requests 108.

Gift registry system 122 searches social networks and vendor websites by using web crawlers such as web crawler 152. In particular, gift registry system 122 may search for current interests 144, friends of friends, and items 148 using web crawler 152.

Still more particularly, gift registry system 122 may perform these searches using web crawler 152. For example, query languages such as SPARQL, RDQL, SeRQL, and any other suitable query language can be used by computers in computer system 120 to make search requests to web crawler 152. In this example web crawler 152 performs the search request by crawling the Internet searching for products comprising any suitable product attributes that meet the search request.

The illustration of gift registry environment 100 in FIG. 1 is not meant to imply physical or architectural limitations to the manner in which different illustrative embodiments may be implemented. Other components in addition to, and/or in place of, the ones illustrated may be used. Some components may be unnecessary. Also, the blocks are presented to illustrate some functional components. One or more of these blocks may be combined and/or divided into different blocks when implemented in an illustrative embodiment.

For example, in some illustrative examples, additional gift registry systems, in addition to gift registry system 122, may be present within network 112. Also, although gift registry system 122 is shown as a block separate from group of computer systems 114, gift registry system 122 may be implemented in computer system 120. In still other examples, gift registry system 122 may be implemented in one or more computer systems in group of computer systems 114.

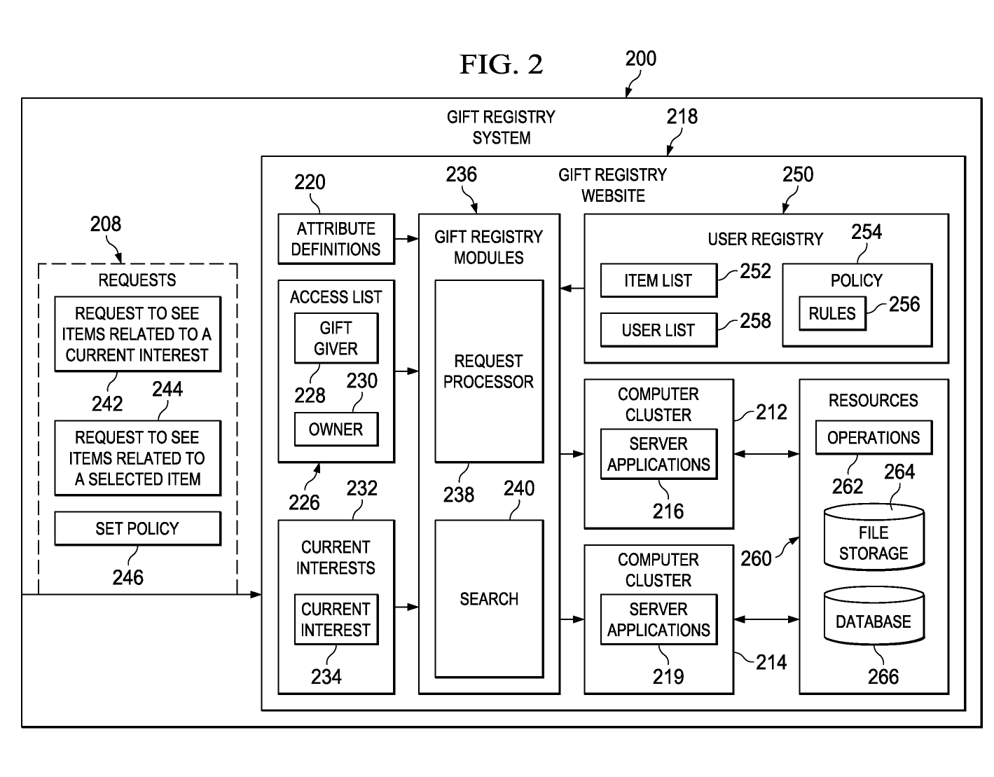

With reference now to FIG. 2, an illustration of a gift registry system is depicted in accordance with an illustrative embodiment. Gift registry system 200 is an example of one implementation of gift registry system 122 in gift registry environment 100 in FIG. 1.

In this illustrative example gift registry system 200 receives requests 208 for gift registry website 218. In this illustrative example, gift registry website 218 includes computer cluster 212 and computer cluster 214. Server applications 216 run on computer cluster 212. Server applications 219 run on computer cluster 214. A computer cluster is a group of computers that work together to process requests. A computer cluster may be viewed as a single computer by clients in some cases.

In these illustrative examples, computer cluster 212 and computer cluster 214 are examples of computer systems in group of computer systems 114 in FIG. 1. In other words, computer cluster 212 and computer cluster 214 form a group of computer systems.

Server applications 216 and server applications 219 perform operations 262 using resources 260. In these illustrative examples, resources 260 comprise file storage 264 and database 266.

Request processor 238 processes requests 208. Request processor 238 also identifies server applications within server applications 216 and server applications 219 to process requests 208. Request processor 238 identifies and retrieves any information needed to process requests 208. The information needed to process the requests may be in the form of information that is identified or retrieved. In these illustrative examples, information is identified, retrieved from, and stored in at least one of memory, file storage 264, database 266, and any other suitable means for identifying, retrieving and storing information. Request processor 238 may be one module of a number of modules in gift registry modules 236. Other modules, such as search 240 may also be included in gift registry modules 236. For example, search 240 may be used by request processor 238 to perform requests 208.

In these illustrative examples, the information needed to process requests may include user registry 250 in gift registry website 218. User registry 250 is a gift registry comprising item list 252, policy 254, and user list 258. Item list 252 is at least one of a gift list and a backup list. For example, when an item in a gift list of a gift registry is not available, a backup list may be used for identifying replacement items. Item list 252 comprises a number of products, or services, or a combination of products, services, and any other suitable gifts.

In these illustrative examples, policy 254 comprises a number of rules 256. User list 258 comprises of a number of people related to the user. These people may be, for example, without limitation, friends, associates, relatives, and other people that have a connection to the user. Access list 226 is a list of users of the gift registry and may comprise any number of gift givers and gift receivers. Gift receivers are the owners of the gift registry. Gift giver 228 and owner 230 make requests 208. Owner 230 is an owner of the gift registry who receives gifts from gift givers such as gift giver 228. Further, attribute definitions 220 comprise a number of attribute definitions usable for identifying items.

In these illustrative examples, request processor 238 may receive a request from a user of a web browser to see items related to the current interest of a gift registry owner. This request takes the form of request to see items related to a current interest 242. Current interests 232 is used by gift registry system 200 to identify current interests, such as current interest 234.

In another illustrative example, request processor 238 may receive a request from a user of a web browser to see items that are related to an item selected by the user. This request takes the form of request to see items related to a selected item 244 in this illustrative example. For example, the item selected by the user may be an out of stock item, or otherwise unavailable item. In this example, the user's request is for finding a replacement item related to the unavailable item. In another example, the item selected by the user may be an item that the user added to a wish list. The user in this example is requesting to see a list of related items so he may browse them and consider adding the related items to the wish list.

In still another illustrative example, request processor 238 may receive a request from a client computer to set a policy comprising one or more rules for selecting items. This request takes the form of set policy 246 in this illustrative example.

The illustration of gift registry system 200 in FIG. 2 is not meant to imply physical or architectural limitations to the manner in which different illustrative embodiments may be implemented. Other components in addition to, and/or in place of, the ones illustrated may be used. Some components may be unnecessary. Also, the blocks are presented to illustrate some functional components. One or more of these blocks may be combined and/or divided into different blocks when implemented in an illustrative embodiment.

For example, in other illustrative examples, the computer systems also may include just a computer in addition to computer cluster 212 and computer cluster 214. In still other illustrative examples, additional computer clusters may be present. Also, additional request processors, in addition to request processor 238, may be used. Other gift registry websites may be present in addition to gift registry website 218. Other user registries may be present in addition to user registry 250. Further, other item lists may be present in addition to item list 252. Still further, other policies may be present in addition to policy 254. Also, other current interest lists may be used in addition to current interests 232. Other server applications also may be used in addition to server applications 216 and server applications 219 to process requests 208 and other requests.

For example, a shopping cart application could be used to process a request to purchase a gift for the owner of the gift registry. In still another example, a reporting application could be used by an owner of the gift registry to process a request to see a report of the status of items in item list 252. In this example, the statuses of the items in item list 252 may include whether the item has been selected to be given as a gift, whether the item is in stock, and other suitable status for items in a gift registry.

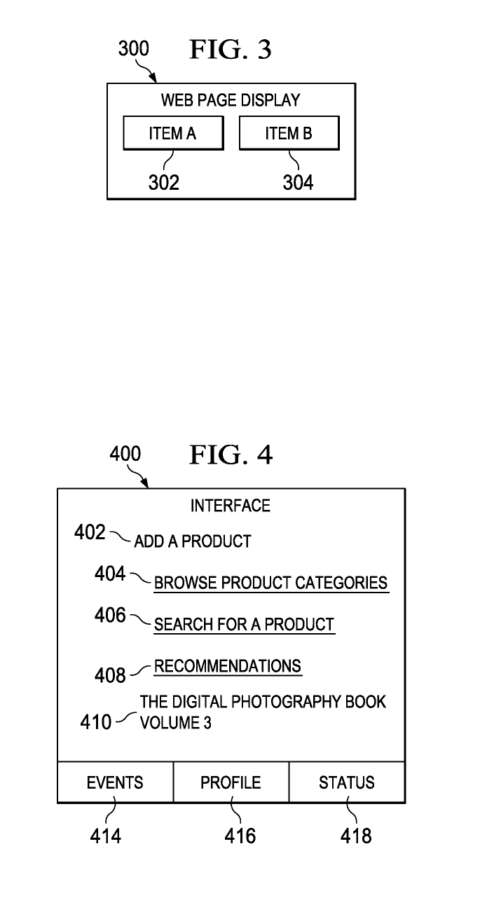

With reference now to FIG. 3, an illustration of a web page is depicted in accordance with an illustrative embodiment. Web page display 300 is an example web page of vendor website 146 in FIG. 1. Web page display 300 comprises information including item a 302 and item b 304.

In these illustrative examples, the web page shown on web page display 300 may be processed by web crawler 152 in FIG. 1. For example, processing of web page display 300 by web crawler 152 may include browsing, parsing, and indexing the web page. The indexing of the web page shown on web page display 300 enables the information shown on web page display 300 to be searched.

In these illustrative examples, web page display 300 may be browsed by a client application, such as web browser 106 in FIG. 1. In these illustrative examples, when browsing web page display 300, user 110 in FIG. 1 may identify item a 302 and item b 304 for use in requests 108 in FIG. 1.

With reference now to FIG. 4, an illustration of a user interface of a gift registry comprising items matching a current interest of a user is depicted in accordance with an illustrative embodiment. Interface 400 is an example of a user interface for gift registry website 218 in FIG. 2. In these illustrative examples, users use interface 400 to make requests 108 for services 118 in FIG. 1.

As depicted in this illustrative example, interface 400 comprises a number of user selectable user interface options to add a product 402, browse product categories 404, search for a product 406, browse and select recommendations 408, browse a log of events 414, browse profile 416, and browse status 418.

In these illustrative examples, selecting recommendations 408 comprises selecting one of a number of recommended items. For example, “The Digital Photography Book Vol. 3” 410 is an example of a recommended item that is selectable using interface 400. In particular, selected items may be added to item list 252 in FIG. 2.

“Descriptive attributes”, as used herein, are attributes that describe products in a way that is understood by a computer. Further, these descriptive attributes can take the form of a standard used to describe semantics about products. For example, resource description framework in attributes (RDFa) is a standard for descriptive attributes.

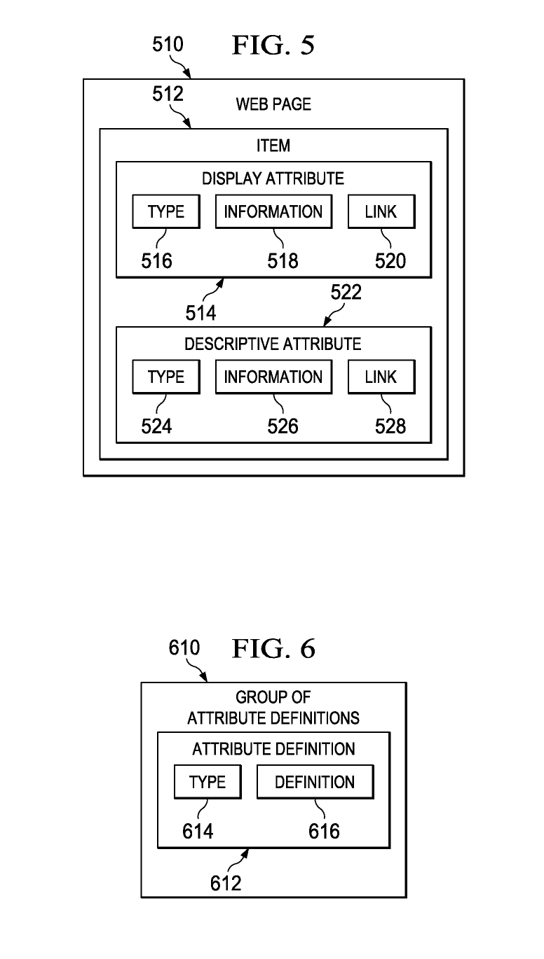

With reference now to FIG. 5, an illustration of an item of a web page is depicted in accordance with an illustrative embodiment. In this illustrative example, item 512 of web page 510 is an example of an item in items 148 in vendor website 146 in FIG. 1. In particular, FIG. 5 illustrates a mapping of display attributes and descriptive attributes in item 512. Still more particularly, the display attributes and descriptive attributes in item 512 describe an item. For example, the item may be a number of products, services, a combination of products and services, or any other suitable gifts for sale on vendor website 146.

In this illustrative example, item 512 comprises display attribute 514 and descriptive attribute 522. Display attribute 514 comprises type 516, information 518, and link 520. Descriptive attribute 522 comprises type 524, information 526, and link 528. In these illustrative examples item 512 may comprise any number of display attributes and any number of descriptive attributes.

Type 516 in display attribute 514 is the type of information 518 or the type of information retrievable from link 520. In these illustrative examples, type 516 may comprise any type recognizable by a web browser to render item 512. For example, type 516 may be an image type, and link 520 may be a uniform resource locator (URL) to an image file.

Type 524 in descriptive attribute 522 is a descriptive type of information 526 or a descriptive type of information retrievable from link 528. In these illustrative examples, type 524 may comprise any descriptive type recognizable by a web crawler to index item 512. For example, type 524 may be a document type and link 528 may be a URL to a document file. In this example, the document file, referenced by link 528, comprises information about item 512. In another example, type 524 may be the author and information 526 may be the author of a product described by item 512.

In these illustrative examples, item 512 may be processed by web crawler 152 in FIG. 1. The processing performed on item 512 by web crawler 152 may include accessing, parsing, and indexing item 512. In particular, descriptive attribute 522 may be indexed by web crawler 152 for the purpose of indexing machine-readable descriptions of item 512. The indexing of item 512 enables the item represented by item 512 to be searched.

In these illustrative examples, item 512 may be browsed by client applications, such as web browser 106 in FIG. 1. In these illustrative examples, when browsing item 512, user 110 in FIG. 1 may identify item 512 for use in requests 108 in FIG. 1.

With reference now to FIG. 6, an illustration of attribute definitions is depicted in accordance with an illustrative embodiment. In this illustrative example, group of attribute definitions 610 is an example of one implementation of attribute definitions 220 in gift registry website 218 in gift registry system 200 in FIG. 2.

In this illustrative example, attribute definition 612 is an attribute definition in group of attribute definitions 610. In this illustrative example, attribute definition 612 comprises type 614 and definition 616. Type 614 in attribute definition 612 is a descriptive type of information. In this illustrative example, type 614 in attribute definition 612 matches type 524 in FIG. 5. For example, types such as type 614 and type 524, may include a name, identifier, author, quality, purpose, size, price, availability, classification, and any other suitable type used to describe information.

In these illustrative examples, two or more of a number of different attribute definitions in group of attribute definitions 610 may have the same type 614. When two or more definitions match the same type, the illustrative examples use rules to decide which definition most closely matches the intended definition. Rules 256 in FIG. 2 is an example of rules used to decide which definition most closely matches the intended definition.

In these illustrative examples, group of attribute definitions 610 may be browsed by client applications 104 in FIG. 1, such as web browser 106 in FIG. 1. In these illustrative examples, user 110 identifies rules to select particular attribute definitions from two or more definitions having the same type 614. For example, when browsing group of attribute definitions 610, user 110 in FIG. 1 may identify attribute definition 612 for use in requests 108 in FIG. 1.

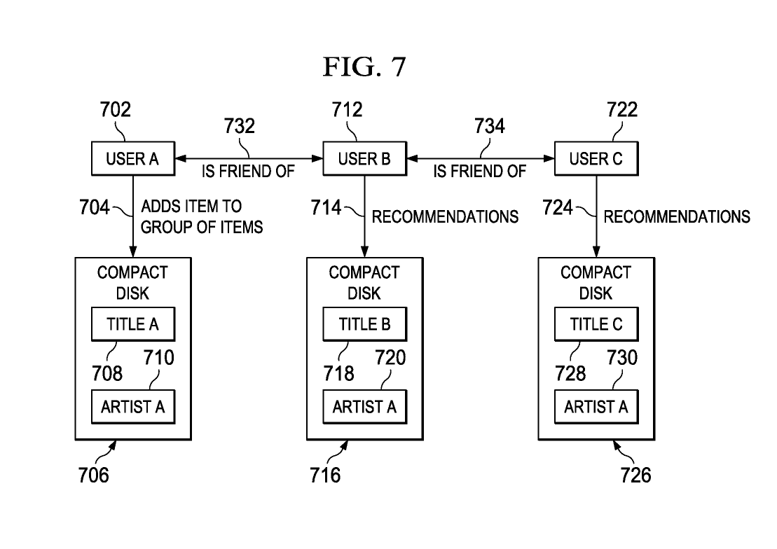

With reference now to FIG. 7, an illustration of a mapping of a user to friends of the user and to product recommendations made by the friends is depicted in accordance with an illustrative embodiment. In this illustrative example, user A 702, user B 712, and user C 722 are examples of users.

In this illustrative example, compact disk 706, compact disk 716, and compact disk 726 are examples of items. Compact disk 706 is identified as title A 708 by artist A 710. Compact disk 716 is identified as title B 718 by artist A 720. Compact disk 726 is identified as title C 728 by artist A 730. In particular, compact disk 716 and compact disk 726 are recommendations 714 and 724. Still more particularly, compact disk 706 is an example of an item in item list 252 in FIG. 2. Compact disk 706 is an example of an item in items 148 in FIG. 1 in vendor website 146 in FIG. 1.

“A friend”, as used herein, means a family member, an associate, an organization, and any other suitable entity that can make trusted recommendations. In these illustrative examples, the set of people that are zero degrees of separation from a user means the set of friends is known to the user. In these examples the set of people that are one degree of separation from a user means the set of friends are known to the set of friends that are known to the user. Thus, in these illustrative examples, the number of degrees of separation from a user means, the smallest number of friends required to form a graph mapping a friend to friends of friends.

In this illustrative example, user B 712 is friend of 732 user A 702. User B 712 is considered to have zero degrees of separation from user A 702. User C 722 is friend of 734 user B 712. User C 722 is considered to have zero degrees of separation from user B 712 and one degree of separation from user A 702.

FIGS. 3-7 are for purposes of illustrating example implementations. These illustrations are merely illustrative examples and are not meant to imply limitations to the manner in which other examples may be implemented.

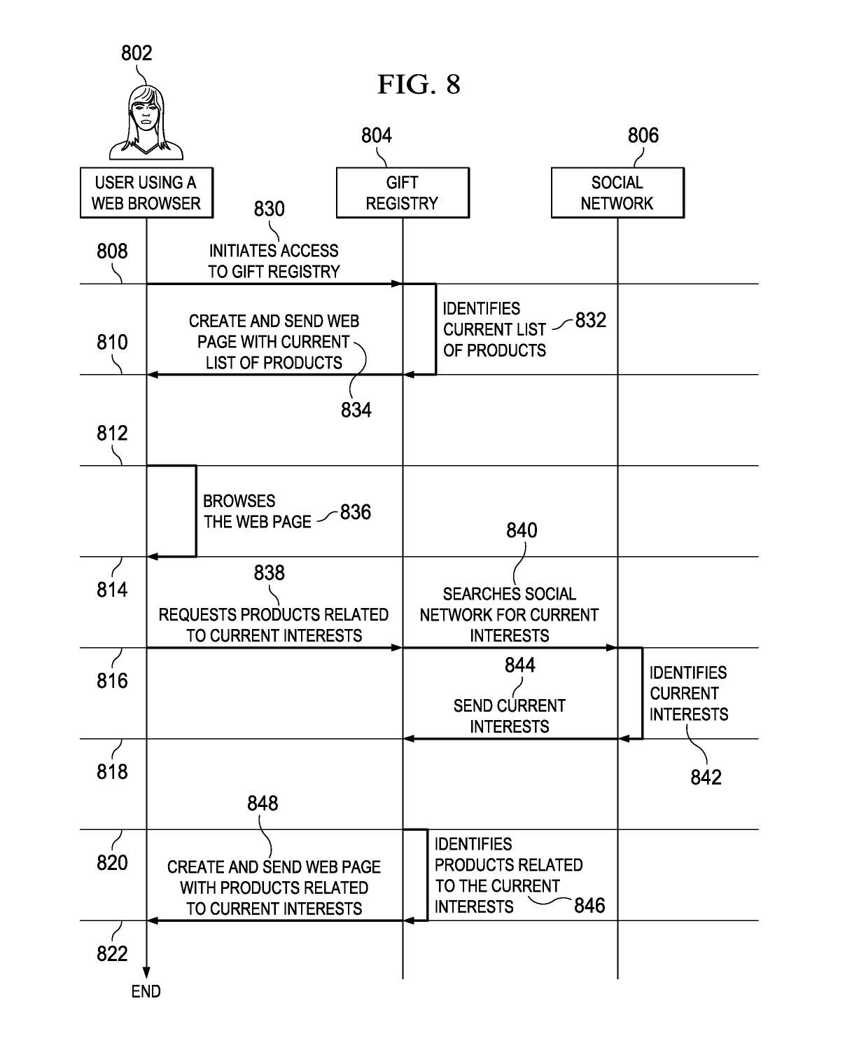

With reference now to FIG. 8, a diagram illustrating steps in a process for identifying products related to current interests is depicted in accordance with an illustrative embodiment. The steps illustrated in FIG. 8 may be implemented in gift registry environment 100 in FIG. 1. In particular, these different steps may be implemented by user 110 using web browser 106, gift registry system 122, and social network 142 in gift registry environment 100. The steps may be implemented using software, hardware, or a combination of the two.

The steps begin with user 802 using a web browser to initiate access to gift registry 804 (step 830). In this illustrated sequence user 802 is an example of user 110 in FIG. 1. The web browser used by user 802 is an example of web browser 106 in FIG. 1. Gift registry 804 is an example of gift registry system 122 in FIG. 1, and social network 806 is an example of social network 142 in FIG. 1.

After step 830, gift registry 804 identifies current list of products for user 802 (step 832). Gift registry 804 creates and sends a web page comprising the identified current list of products to the web browser of user 802 (step 834). User 802 browses the web page sent by gift registry 804 comprising the current list of products (step 836). In this illustrative sequence, a current list of products may be item list 252 in user registry 250 in gift registry website 218 in FIG. 2.

User 802 then uses a web browser to send a request for products related to current interests to gift registry 804 (step 838). In this illustrated sequence products are identified as products related to current interests. In these illustrated examples, current interests may comprise the current interests of a particular user or person, such as the owner of a gift registry or a gift receiver.

Gift registry 804 searches social network 806 for current interests (step 840). After step 840 social network 806 identifies current interests for gift registry 804's search (step 842). Social network 806 then sends identified current interests to gift registry 804 (step 844). Gift registry 804 identifies a set of products related to current interests using current interests received from social network 806 (step 846). In these illustrative examples, the identified set of products related to current interests are products having attributes that identify the products as usable for one or more of the identified current interests.

Gift registry 804 then creates and sends another web page comprising products related to current interests to the web browser of user 802 (step 848), with the process terminating thereafter.

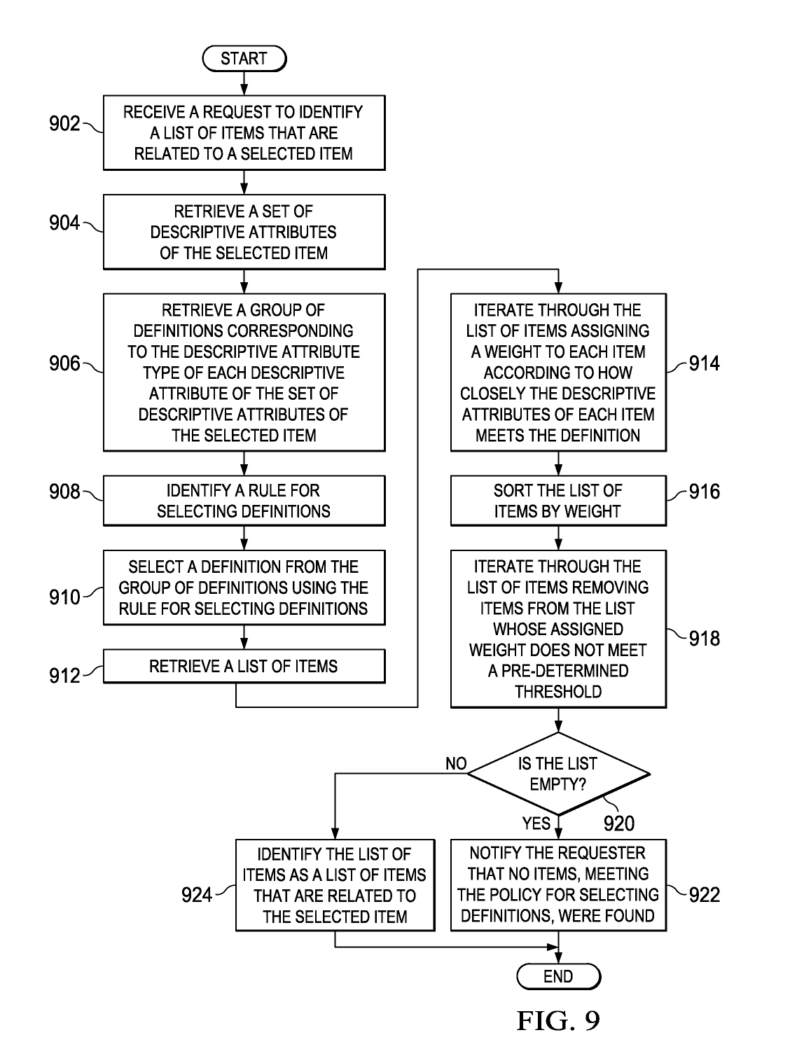

With reference now to FIG. 9, an illustration of a flowchart of a process for identifying a list of items related to a selected item is depicted in accordance with an illustrative embodiment. The process illustrated in FIG. 9 may be implemented in gift registry environment 100 in FIG. 1. In particular, these different steps may be implemented in gift registry system 122 in FIG. 1. Still more particularly, these different steps may be implemented by request processor 238 in FIG. 2. The steps may be implemented using software, hardware, or a combination of the two.

The process begins by receiving a request to identify a list of items that are related to a selected item (step 902). The process retrieves a set of descriptive attributes of the selected item (step 904). The process retrieves a group of definitions corresponding to the descriptive attribute type of each descriptive attribute of the set of descriptive attributes of the selected item (step 906). The process identifies a rule for selecting definitions (step 908). The process selects a definition from the group of definitions using the rule for selecting definitions (step 910).

The process retrieves a list of items (step 912). The process iterates through the list of items assigning a weight to each item according to how closely the descriptive attributes of each item meet the definition (step 914). The process then sorts the list of items by weight (step 916). The process then iterates through the list of items removing items from the list whose assigned weight does not meet a pre-determined threshold (step 918).

A determination is then made as to whether the list is empty (step 920). If the list is empty, the process notifies the requester that no items, meeting the policy for selecting definitions, were found (step 922). Otherwise, if the list was not empty, the process identifies the list of items as a list of items that are related to the selected item (step 924) with the process terminating thereafter.

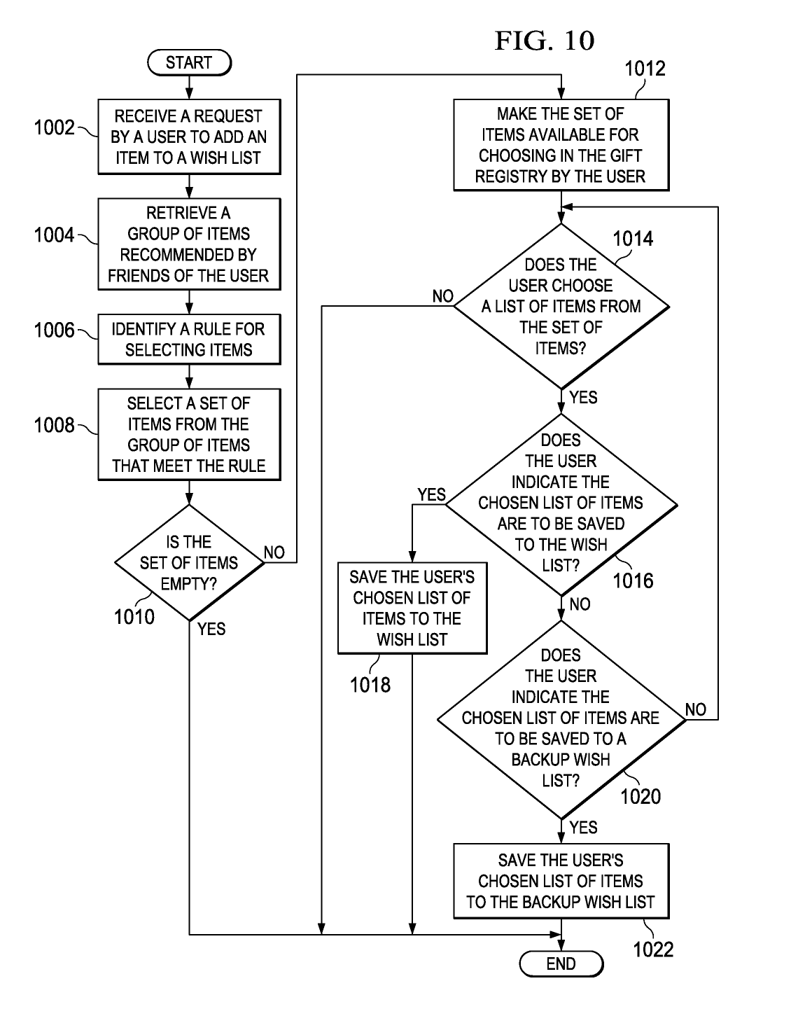

With reference now to FIG. 10, an illustration of a flowchart of a process to identify a list of approved product recommendations is depicted in accordance with an illustrative embodiment. The process illustrated in FIG. 10 may be implemented in gift registry environment 100 in FIG. 1. In particular, these different steps may be implemented in gift registry system 122 in FIG. 1. The steps may be implemented using software, hardware, or a combination of the two.

The process begins by receiving a request by a user to add an item to a wish list (step 1002). The process retrieves a group of items recommended by friends of the user (step 1004). For example, the user may be user A 702 in FIG. 7 and the process may retrieve recommended compact disks 716 or 726 in FIG. 7. The process then identifies a rule for selecting items (step 1006). The process then selects a set of items from the group of items that meet the rule (step 1008).

A determination is then made as to whether the set of items is empty (step 1010). If the list was empty, the process terminates. Otherwise, if the set of items is not empty, the process makes the set of items available for choosing in the gift registry by the user (step 1012). For example, to make the set of items available for choosing in the gift registry by the user, the process may generate and then send a web page comprising the set of items to the user's web browser.

A determination is then made as to whether the user chooses a list of items from the set of items (step 1014). If the user does not choose a list of items from the set of items, the process terminates. Otherwise, if a user chooses a list of items from the set of items, a determination is made as to whether the user indicates the list of items is to be saved to a wish list (step 1016). If the user indicated the list of items is to be saved to a wish list the process saves the list of items to the wish list (step 1018). The process then terminates.

With reference again to step 1016, if the user does not indicate the list of items is to be saved, a determination is made as to whether the user indicates the list of items is to be saved to a backup wish list. If the user did not indicate the list of items is to be saved to a backup wish list the process returns to step 1014. If the user indicated the list of items is to be saved to a backup wish list the process saves the list of items to the backup wish list (step 1022). The process then terminates.

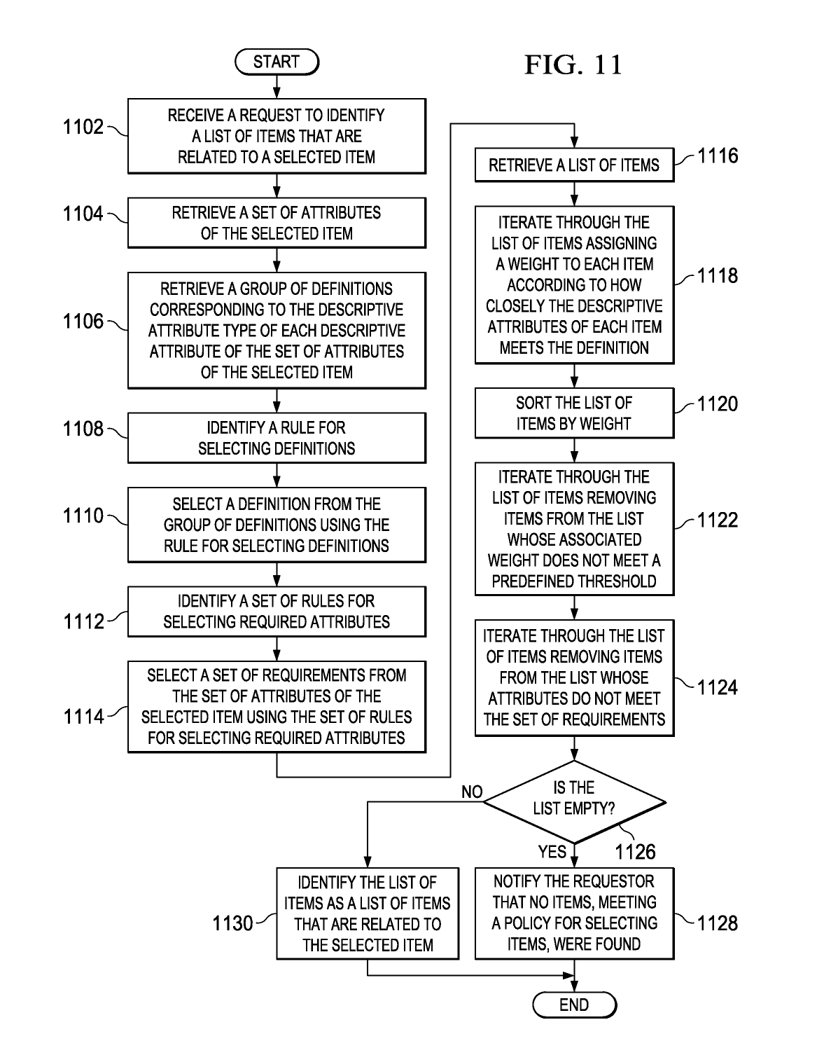

With reference now to FIG. 11, an illustration of a flowchart of another process for identifying a list of items related to a selected item is depicted in accordance with an illustrative embodiment. The process illustrated in FIG. 11 may be implemented in gift registry environment 100 in FIG. 1. In particular, these different steps may be implemented in gift registry system 122 in FIG. 1. The steps may be implemented using software, hardware, or a combination of the two.

The process begins by receiving requests to identify a list of items that are related to a selected item (step 1102). The process retrieves a set of attributes of the selected item (step 1104). The process retrieves a group of definitions corresponding to the descriptive attribute type of each descriptive attribute of the set of attributes of the selected item (step 1106). The process identifies a rule for selecting definitions (step 1108).

The process selects a definition from the group of definitions using the rule for selecting definitions (step 1110). The process identifies a set of rules for selecting required attributes (step 1112). The process selects a set of requirements from the set of attributes of the selected item using the set of rules for selecting required attributes (step 1114). For example, the set of attributes of the selected item may include a name of the selected item, a description of the selected item, a unique identifier of the selected item, a vendor name of the selected item, a cost of the selected item, a measure of quality of the selected item, and an availability of the selected item. In this example, the set of requirements may include the measure of quality and the rule may be that replacement items have a similar measure of quality.

The process retrieves a list of items (step 1116). The process iterates through the list of items assigning a weight to each item according to how closely the descriptive attributes of each item meets the definition (step 1118). The process then sorts the list of items by weight (step 1120). The process then iterates through the list of items removing items from the list whose assigned weight does not meet a pre-determined threshold (step 1122). The process then iterates through the list of items removing items from the list whose attributes do not meet the set of requirements (step 1124).

A determination is then made as to whether the list is empty (step 1126). If the list is empty, the process notifies the requester that no items, meeting the policy for selecting definitions, were found (step 1128) with the process terminating thereafter. Otherwise if the list was not empty, the process identifies the list of items as a list of items that are related to the selected item (step 1130) with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent a module, segment, function, and/or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams.

In some alternative implementations of an illustrative embodiment, the function or functions noted in the block may occur out of the order noted in the figures. For example, in some cases, two blocks shown in succession may be processed substantially concurrently, or the blocks may sometimes be processed in the reverse order, depending upon the functionality involved. Also, other blocks may be added in addition to the illustrated blocks in a flowchart or block diagram.

For example, step 1122 may be unnecessary in some examples. As another illustrative example, retrieving the list of items may be made from more than one vendor website, depending on the implementation. In yet another example, steps 1106, 1108, 1112, 1118, 1120, and 1122 may be optional steps. In other words, one or all of these steps may be omitted, depending on the implementation. Of course, these example modifications to the processes are merely examples of changes that may be made, and other changes may also be made for other illustrative embodiments.

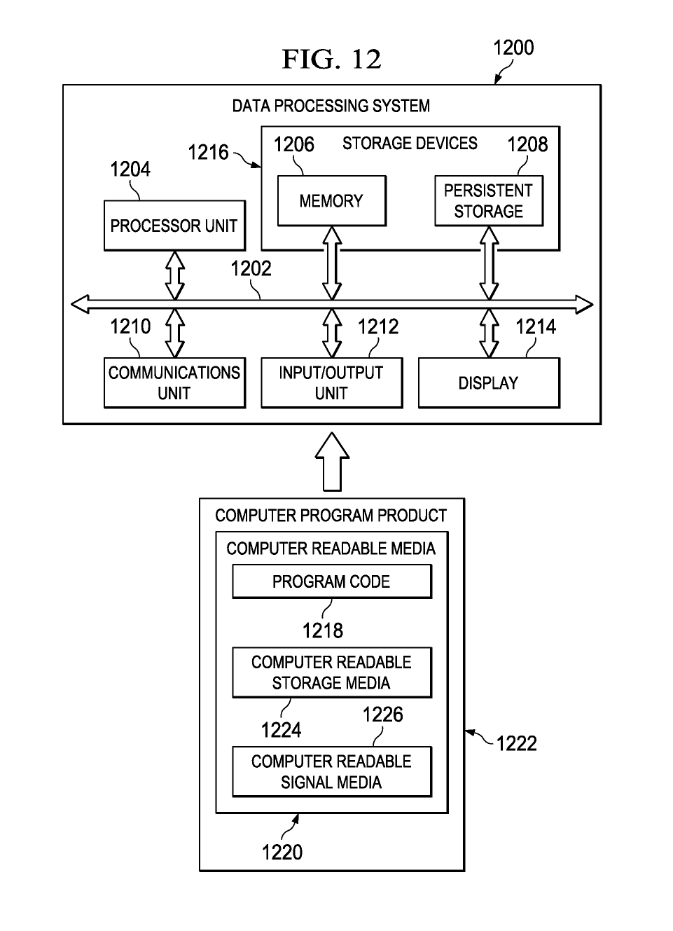

Turning now to FIG. 12, an illustration of a data processing system is depicted in accordance with an illustrative embodiment. In this illustrative example, data processing system 1200 includes communications fabric 1202, which provides communications between processor unit 1204, memory 1206, persistent storage 1208, communications unit 1210, input/output (I/O) unit 1212, and display 1214. Data processing system 1200 is an example of a data processing system that may be used to implement server applications based on common resources. Data processing system 1200 is also an example of a data processing system that may be used to implement client computers 104 and computer system 120 or other computer systems within group of computer systems 114 in FIG. 1. Data processing system 1200 also may be used to implement client computer 206 and computers within computer cluster 212 and computer cluster 214 in FIG. 2.

Processor unit 1204 serves to process instructions for software that may be loaded into memory 1206. Processor unit 1204 may be a number of processors, a multi-processor core, or some other type of processor, depending on the particular implementation. A number, as used herein with reference to an item, means one or more items. Further, processor unit 1204 may be implemented using a number of heterogeneous processor systems in which a main processor is present with secondary processors on a single chip. As another illustrative example, processor unit 1204 may be a symmetric multi-processor system containing multiple processors of the same type.

Memory 1206 and persistent storage 1208 are examples of storage devices 1216. A storage device is any piece of hardware that is capable of storing information, such as, for example, without limitation, data, program code in functional form, and/or other suitable information either on a temporary basis and/or a permanent basis. Storage devices 1216 may also be referred to as computer readable storage devices in these examples. Memory 1206, in these examples, may be, for example, a random access memory or any other suitable volatile or non-volatile storage device. Persistent storage 1208 may take various forms, depending on the particular implementation.

For example, persistent storage 1208 may contain one or more components or devices. For example, persistent storage 1208 may be a hard drive, a flash memory, a rewritable optical disk, a rewritable magnetic tape, or some combination of the above. The media used by persistent storage 1208 also may be removable. For example, a removable hard drive may be used for persistent storage 1208.

Communications unit 1210, in these examples, provides for communications with other data processing systems or devices. In these examples, communications unit 1210 is a network interface card. Communications unit 1210 may provide communications through the use of either or both physical and wireless communications links.

Input/output unit 1212 allows for input and output of data with other devices that may be connected to data processing system 1200. For example, input/output unit 1212 may provide a connection for user input through a keyboard, a mouse, and/or some other suitable input device. Further, input/output unit 1212 may send output to a printer. Display 1214 provides a mechanism to display information to a user.

Instructions for the operating system, applications, and/or programs may be located in storage devices 1216, which are in communication with processor unit 1204 through communications fabric 1202. In these illustrative examples, the instructions are in a functional form on persistent storage 1208. These instructions may be loaded into memory 1206 for processing by processor unit 1204. The processes of the different embodiments may be performed by processor unit 1204 using computer-implemented instructions, which may be located in a memory, such as memory 1206.

These instructions are referred to as program code, computer usable program code, or computer readable program code that may be read and processed by a processor in processor unit 1204. The program code in the different embodiments may be embodied on different physical or computer readable storage media, such as memory 1206 or persistent storage 1208.

Program code 1218 is located in a functional form on computer readable media 1220 that is selectively removable and may be loaded onto or transferred to data processing system 1200 for processing by processor unit 1204. Program code 1218 and computer readable media 1220 form computer program product 1222 in these examples. In one example, computer readable media 1220 may be computer readable storage media 1224 or computer readable signal media 1226.

Computer readable storage media 1224 may include, for example, an optical or magnetic disk that is inserted or placed into a drive or other device that is part of persistent storage 1208 for transfer onto a storage device, such as a hard drive, that is part of persistent storage 1208. Computer readable storage media 1224 also may take the form of a persistent storage, such as a hard drive, a thumb drive, or a flash memory, that is connected to data processing system 1200.

In some instances, computer readable storage media 1224 may not be removable from data processing system 1200. In these examples, computer readable storage media 1224 is a physical or tangible storage device used to store program code 1218 rather than a medium that propagates or transmits program code 1218. Computer readable storage media 1224 is also referred to as a computer readable tangible storage device or a computer readable physical storage device. In other words, computer readable storage media 1224 is a media that can be touched by a person.

Alternatively, program code 1218 may be transferred to data processing system 1200 using computer readable signal media 1226. Computer readable signal media 1226 may be, for example, a propagated data signal containing program code 1218. For example, computer readable signal media 1226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1218 may be downloaded over a network to persistent storage 1208 from another device or data processing system through computer readable signal media 1226 for use within data processing system 1200. For instance, program code stored in a computer readable storage medium in a server data processing system may be downloaded over a network from the server to data processing system 1200. The data processing system providing program code 1218 may be a server computer, a client computer, or some other device capable of storing and transmitting program code 1218.

The different components illustrated for data processing system 1200 are not meant to provide architectural limitations to the manner in which different embodiments may be implemented. The different illustrative embodiments may be implemented in a data processing system including components in addition to or in place of those illustrated for data processing system 1200. Other components shown in FIG. 12 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1204 may take the form of a hardware unit that has circuits that are manufactured or configured for a particular use. This type of hardware may perform operations without needing program code to be loaded into a memory from a storage device to be configured to perform the operations.

For example, when processor unit 1204 takes the form of a hardware unit, processor unit 1204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1218 may be omitted, because the processes for the different embodiments are implemented in a hardware unit.

In still another illustrative example, processor unit 1204 may be implemented using a combination of processors found in computers and hardware units. Processor unit 1204 may have a number of hardware units and a number of processors that are configured to run program code 1218. With this depicted example, some of the processes may be implemented in the number of hardware units, while other processes may be implemented in the number of processors.

In another example, a bus system may be used to implement communications fabric 1202 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of devices that transmit data, receive data, or transmit and receive data. A communications unit may be, for example, a modem or a network adapter, two network adapters, or some combination thereof. Further, a memory may be, for example, memory 1206, or a cache, such as found in an interface and memory controller hub that may be present in communications fabric 1202.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

What is claimed is:

1. A method for managing a gift registry, the method comprising:
identifying, by a computer system, a first set of attributes for a first item and a group of definitions describing the first set of attributes of the first item;
selecting, by the computer system, a definition for the first item from the group of definitions using a rule for selecting definitions; and
identifying, by the computer system, a second item for the gift registry using the definition selected using the rule for selecting definitions, wherein the second item has a second set of attributes that meet the definition.

2. The method of claim 1, wherein identifying, by the computer system, the second item for the gift registry using the definition selected using the rule comprises:
searching a group of items for a set of items that meet the definition; and
selecting the second item from the set of items as having the second set of attributes that most closely meets the definition.

3. The method of claim 1, further comprising:
adding, by the computer system, the second item to the gift registry, wherein the second item is made available for selection in the gift registry by a user.

4. The method of claim 1, wherein the second item is made available for selection when the first item is unavailable for selection in the gift registry.

5. The method of claim 1, wherein the rule is a first rule and further comprising:
selecting, by the computer system, a set of required attributes from the set of attributes using a second rule for selecting required attributes;
identifying, by the computer system, a third item for the gift registry using the set of required attributes selected using the second rule for selecting required attributes, wherein the third item has a third set of attributes that meet the set of required attributes; and
identifying, by the computer system, a fourth item for the gift registry using the definition selected using the first rule for selecting definitions and the set of required attributes selected using the second rule for selecting required attributes, wherein the fourth item has a fourth set of attributes that meet the set of required attributes and the definition,

6. The method of claim 5 wherein the first rule for selecting definitions and the second rule for selecting required attributes are defined and identified for each different user of the computer system.

7. The method of claim 2 wherein the group of items comprises items recommended by a first set of people identified to be within a number of degrees of separation from a user of the computer system,

8. The method of claim 1 wherein the first and second item are a product, or services, or a combination of product and services; and
wherein the first and second set of attributes at least include a name of the item, a description of the item, a unique identifier of the item, a vendor name of the item, a cost of the item, a measure of quality of the item, and an availability of the item.

9. The method of claim 2 wherein the group of items comprises items retrieved from a set of networks, wherein the set of networks comprises at least one of a social network and a vendor website network.

10. The method of claim 2 wherein the computer system searching the group of items for the set of items that meet the definition comprises:
the computer system using a query language to retrieve the group of items from the set of networks, wherein each item in the group of items is stored in the set of networks, and each item comprises a set of attributes that describe the item, and the group of definitions describe the set of attributes,

11. An apparatus for managing a gift registry, the apparatus comprising:
a bus system;
a storage device connected to the bus system;
a processor unit; and
program code stored on the storage device, wherein the processor unit is configured to process the program code to identify a first set of attributes for a first item and a group of definitions describing the first set of attributes of the first item; select a definition for the first item from the group of definitions using a rule for selecting definitions; and identify a second item for a gift registry using the definition selected using the rule for selecting definitions, wherein the second item has a second set of attributes that meet the definition.

12. The apparatus of claim wherein the processor unit configured to process the program code to identify the second item for the gift registry using the definition selected using the rule for selecting definitions further comprises the processor unit configured to process the program code to:
search a group of items for a set of items that meet the definition; and
select the second item from the set of items as having the second set of attributes that most closely meets the definition,

13. The apparatus of claim 11 in which the processor unit is further configured to process the program code to add the second item to the gift registry, wherein the second item is made available for selection in the gift registry by a user.

14. The apparatus of claim 12, wherein the group of items comprises items retrieved from a set of networks, wherein the set of networks comprises at least one of a social network and a vendor website network.

15. The apparatus of claim 12, wherein in being configured to process the program code to search the group of items for the set of items that meet the definition, the processor unit is configured to process the program code to use a query language to retrieve the group of items from the set of networks, wherein each item in the group of items is stored in the set of networks, and each of the items comprises a set of attributes that describe the item, and the group of definitions describe the set of attributes.

16. A computer program product for managing a gift registry, the computer program product comprising:
a computer readable storage medium;
first program code for identifying a first set of attributes for a first item and a group of definitions describing the first set of attributes of the first item;
second program code for selecting a definition for the first item from the group of definitions using a rule for selecting definitions; and
third program code for identifying a second item for the gift registry using the definition selected using the rule for selecting definitions, wherein the second item has a second set of attributes that meet the definition, wherein the first program code, the second program code, and the third program code are stored on the computer readable storage medium.

17. The computer program product of claim 16, wherein the third program comprises:
program code for searching a group of items for a set of items that meet the definition; and
program code for selecting the second item from the set of items as having the second set of attributes that most closely meets the definition.

18. The computer program product of claim 16 further comprising:
fourth program code for adding the second item to the gift registry, wherein the second item is made available for selection in the gift registry by a user, and wherein the fourth program code is stored on the computer readable storage medium.

19. The computer program product of claim 17, wherein the group of items comprises items retrieved from a set of networks and the set of networks comprises at least one of a social network and a vendor website network.

20. The computer program product of claim 17, wherein the program code for searching the group of items for the set of items that meet the definition comprises:
program code for using a query language to retrieve the group of items from the set of networks, wherein each item in the group of items is stored in the set of networks, each item comprises a set of attributes that describe the item, and the group of definitions describes the set of attributes.
